(19) United States
(12) Patent Application Publication
(10) Pub. No.: US 2010/0140354 A1
(43) Pub. Date: Jun. 10, 2010

(54) DEBUG DEVICE SHARING A MEMORY CARD SLOT WITH A CARD READER

(75) Inventors: Yu-Chi Chen, Jung-Ho City (TW); Hsiang-Hsing Sung, Jung-Ho City (TW)

Correspondence Address: APEX JURIS, PLLC, 12733 LAKE CITY WAY NORTHEAST, SEATTLE, WA, 98125, US

(73) Assignee: MICRO-STAR INTERNATIONAL CO., LTD., Jung-Ho City (TW)

(21) Appl. No.: 12/330,435

(22) Filed: Dec. 8, 2008

(51) Int. Cl. G06K 7/06

(52) U.S. Cl. 235/441

(57) ABSTRACT

A debug device sharing a memory card slot with a card reader is disclosed in the invention, which utilizes a memory card slot of a card reader as an interface thereof. Users can insert an external debug card into the slot like using a memory card, and examine messages about Power On Self Test codes without removing the case of a computer. A debug circuit is electrically connected between a computer motherboard and an interface of the memory card slot, and the interface of the memory card slot a multiplexed interface shared between a card reader controller and the debug circuit.

### FIELD OF THE INVENTION

The invention relates to a debug card, and more particularly to a debug device implemented in a personal computer that allows users to examine POST codes without removing the case of the computer.

### BACKGROUND OF THE INVENTION

Conventionally, a debug card is applied within a personal computer. After the personal computer is powered on, the process of Power On Self Test (POST) is initiated subsequently, and the Basic Input/Output System (BIOS) then outputs POST codes. A conventional debug card is coupled to the PCI bus or ISA bus of a computer motherboard, and has LEDs or 7-segment displays thereon for indicating the system status. However, the use of a conventional debug card needs to occupy a slot of the computer motherboard, which prevents the computer system from getting further upgrades. Some of the conventional debug cards can be directly built into the computer motherboard, which effectively saves a slot for further uses. However, if the computer system malfunctions, it would require users to remove the case of the computer in order to examine the error messages shown on the debug card, regardless of which type of the aforesaid conventional debug cards is used, and thus results in inconvenience to the users.

It is therefore tried by the inventor of the invention to develop a debug device that can share a memory card slot with a card reader, so as to allow users to examine POST codes without having to remove the case of a computer, in order to solve the problems existing in the conventional debug cards as described above.

### SUMMARY OF THE INVENTION

A primary objective of the invention is to provide a debug device sharing a memory card slot with a card reader, which utilizes a memory card slot of a card reader as an interface thereof, so as to allow users to examine POST codes without removing the case of a computer.

To achieve the aforesaid objective of the invention, the invention has disclosed a debug device sharing a memory card slot with a card reader, comprising: a card reader controller, a first interface, a second interface, and a debug circuit. The first interface is used to allow for at least more than one memory card or external debug card to be inserted thereinto, and to electrically connect the memory card and the card reader controller. The second interface is electrically connected between a computer motherboard and the card reader controller. Characterized in that: The debug circuit is electrically connected between the computer motherboard and the first interface, wherein the first interface is a multiplexed interface shared between the card reader controller and the debug circuit.

### BRIEF DESCRIPTION OF DRAWINGS

The aforesaid objectives, characteristics and advantages of the present invention will be more clearly understood when considered in conjunction with the detailed description of the accompanying embodiment and drawings, in which:

FIG. 1 is a structural view of the circuit that shows a debug device sharing a memory card slot with a card reader according to the invention;

FIG. 2 is a schematic view that shows a debug device according to an embodiment of the invention;

FIG. 3 is a schematic view that shows a debug device according to another embodiment of the invention;

FIG. 4 is a schematic view of the structure that shows a computer having the debug device of the invention;

FIG. 5 is a structural view of the circuit that shows an external debug card used in combination with a debug circuit according to the invention; and

FIG. 6 is a schematic view that shows the appearance of the external debug card from FIG. 5.

### DETAILED DESCRIPTION OF THE INVENTION

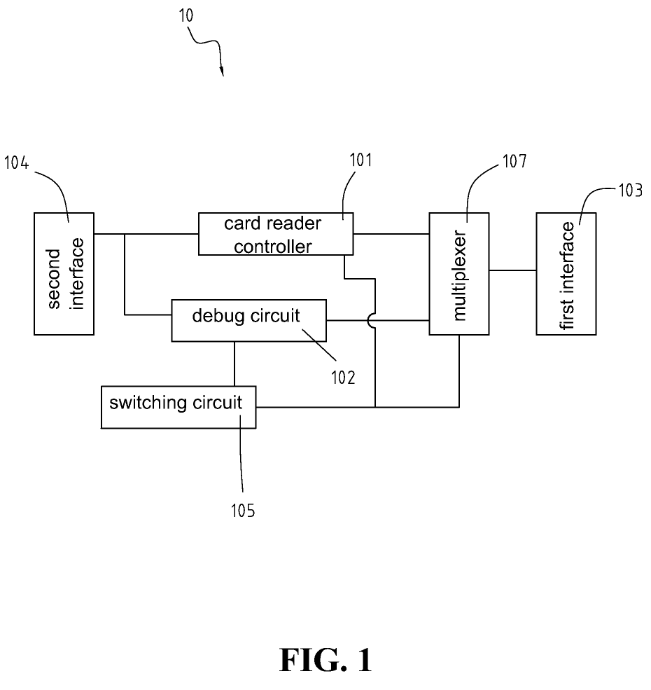

FIG. 1 is a structural view of the circuit that shows a debug device sharing a memory card slot with a card reader according to the invention. According to the invention, a debug device 10 sharing a memory card slot with a card reader comprises: a card reader controller 101, a debug circuit 102, a first interface 103, a second interface 104, and a switching circuit 105, which are respectively described as follows. The card reader controller 101 reads data from or writes data into a memory card in the same way as conventional card reader controllers do. Therefore, circuits in the card reader controller 101 of the invention can be implemented using relevant prior arts of this field.

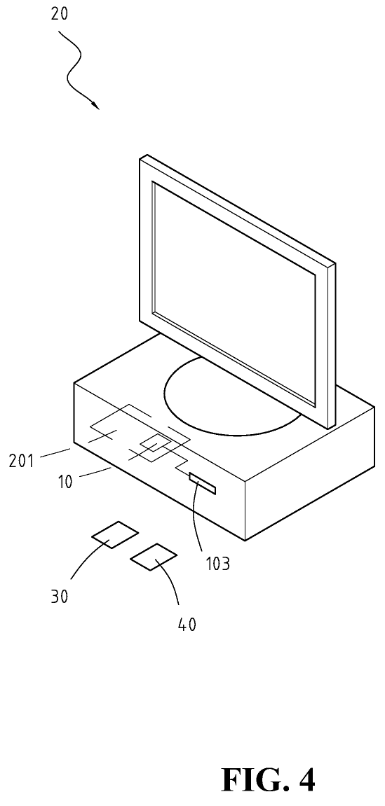

The first interface 103 is used to allow for at least more than one memory card 30 (please refer to FIG. 4) to be inserted thereinto, and to electrically connect the memory card 30 located in the first interface 103 with the card reader controller 101. The implementation of the first interface 103 can be selected from the group consisting of an electrical connection interface matching the SD memory card specification, an electrical connection interface matching the CF memory card specification, an electrical connection interface matching the SDHC memory card specification, an electrical connection interface matching the MMC memory card specification, an electrical connection interface matching the XD memory card specification, and an electrical connection interface matching the MS memory card specification.

The second interface 104 is electrically connected between a computer motherboard 201 (please refer to FIG. 4) and the card reader controller 101. The implementation of the second interface 104 can be selected from the bus interfaces consisting of an ISA interface, a PCI interface, a PCI-E interface, and an USB interface. An external memory card 30 can be electrically connected to the computer motherboard 201 via the first interface 103, the card reader controller 101, and the second interface 104.

The debug circuit 102 is electrically connected between the computer motherboard 201 and the first interface 103. After a computer 20 (please refer to FIG. 4) is powered on, the process of Power On Self Test (POST) is initiated subsequently, and the Basic Input/Output System (BIOS) then outputs BIOS POST codes. For example, the BIOS can output BIOS POST codes via Port 80. The debug circuit 102 is used to receive the BIOS POST codes, and then transmit signals of the received BIOS POST codes to a display circuit, such that the display circuit can show the signals subsequently. The debug circuit 102 can be directly implemented as circuits related to prior debug cards using Port 80.

The switching circuit 105 is used to switch and select between the card reader controller 101 and the debug circuit 102. When the switching circuit 105 switches and selects the card reader controller 101, the card reader controller 101 is enabled consequently. When the switching circuit 105 switches and selects the debug circuit 102, the debug circuit 102 is enabled consequently.

A multiplexer 107 has two input terminals for respectively connecting to the card reader controller 101 and the debug circuit 102; an output terminal for connecting to the first interface 103, and a data selection signal terminal for connecting to the switching circuit 105.

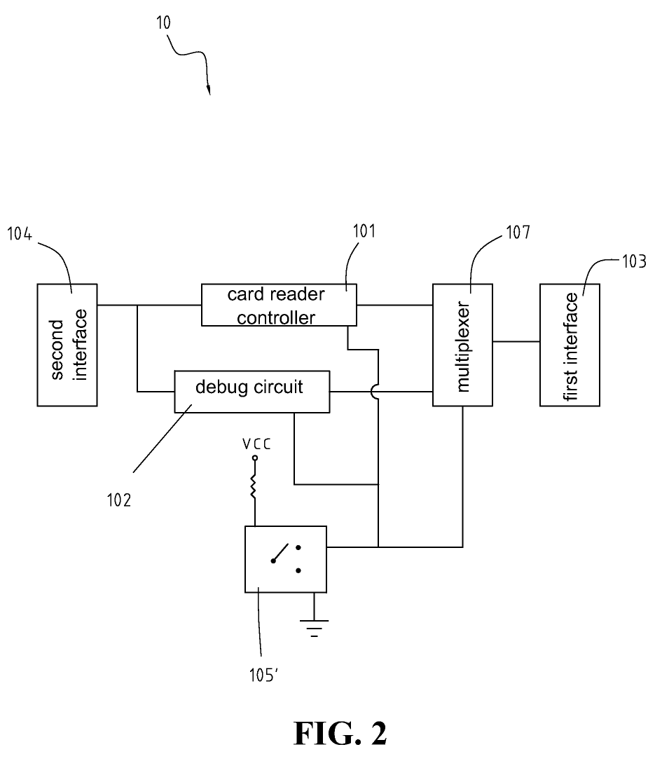

Referring to FIG. 2, in which the switching circuit 105 is implemented as a switch 105′. The switch 105′ can be used to enable the multiplexer 107 to select between the input terminals, and to enable the card reader controller 101 or the debug circuit 102.

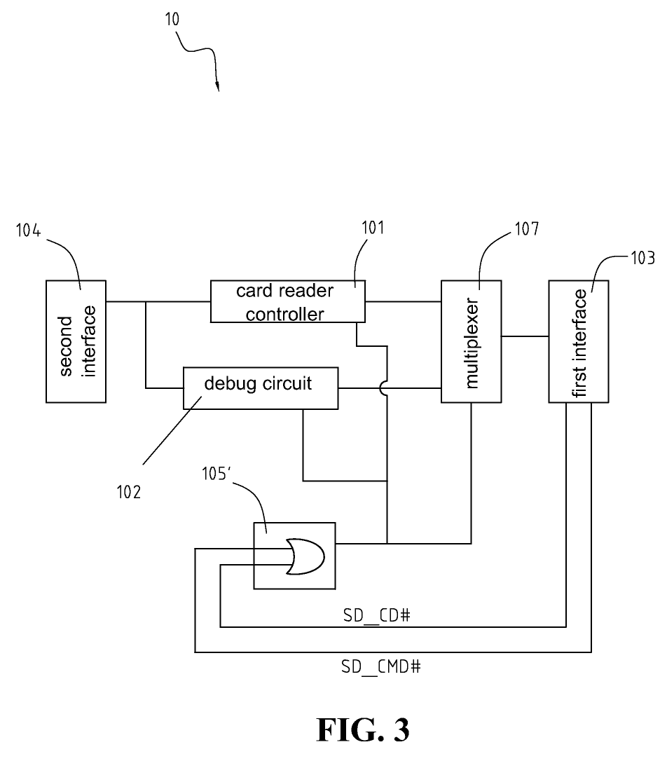

Referring to FIG. 3, in which the switching circuit 105 is implemented as a logic circuit 105′. The logic circuit 105′ has an input terminal for connecting to a part of pins of the first interface 103, as well as an output terminal for connecting to the data selection signal terminal of the multiplexer 107, so as to select between the input terminals of the multiplexer 107. At the same time, the output terminal of the logic circuit 105′ is used to enable either the card reader controller 101 or the debug circuit 102. According to signals (such as the SD_CD# and SD_CMD# signals of the SD memory card specification) from the input terminal, the logic circuit 105′ can automatically determine whether the external card inserted into the first interface 103 is a memory card 30 or a debug card 40. FIGS. 2 and 3 show that the debug circuit 102 is electrically connected to the second interface 104, and the debug circuit 102 is electrically connected to other elements of the computer motherboard 201 via the second interface 104. Moreover, the debug circuit 102 can also be electrically connected to elements of the computer motherboard 201 directly. For instance, the debug circuit 102 can be electrically connected to a southbridge chip directly.

The debug circuit 102 and the card reader controller 101 can be integrated to form an integrated circuit. Alternatively, the debug circuit 102, the card reader controller 101, and the switching circuit 105 can be integrated to form an integrated circuit.

The first interface 103 is a multiplexed interface shared between the card reader controller 101 and the debug circuit 102. By using the switching circuit 105, the card reader controller 101 and the debug circuit 102 can be prevented from conflicting over the first interface 103.

FIG. 4 is a schematic view of the structure that shows a computer having the debug device of the invention. When the switching circuit 105 switches to and selects the card reader controller 101, the first interface 103 is allowed to serve as a transmission interface for the memory card 30. Subsequently, a user can insert the memory card 30 into the first interface 103, and carry out reading, writing, and copying of data between the computer 20 and the memory card 30. When the switching circuit 105 switches to and selects the debug circuit 102, the first interface 103 is allowed to serve as a transmission interface for the debug circuit 102 to transmit the BIOS POST codes. Subsequently, the user can insert the external debug card 40 into the first interface 103, and obtain the BIOS POST codes from a display element 405 of the external debug card 40.

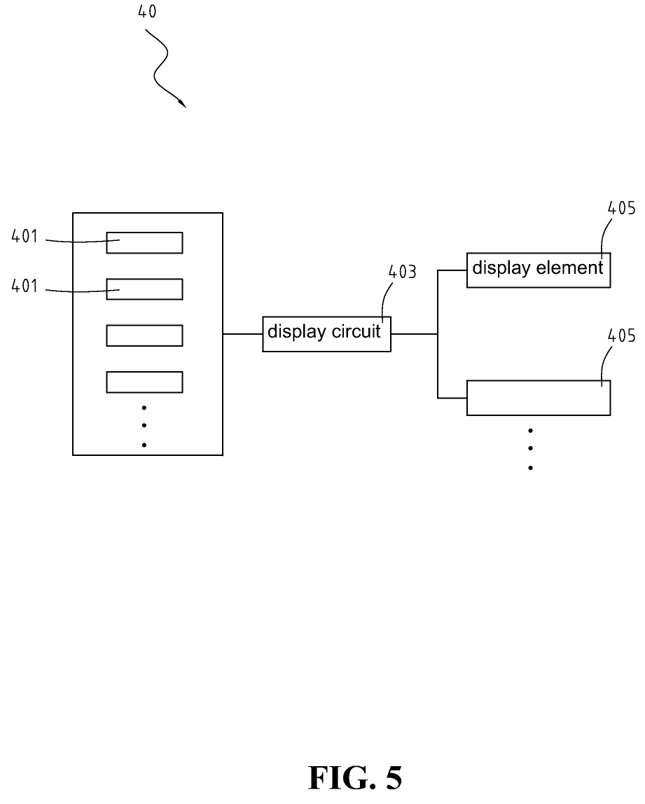

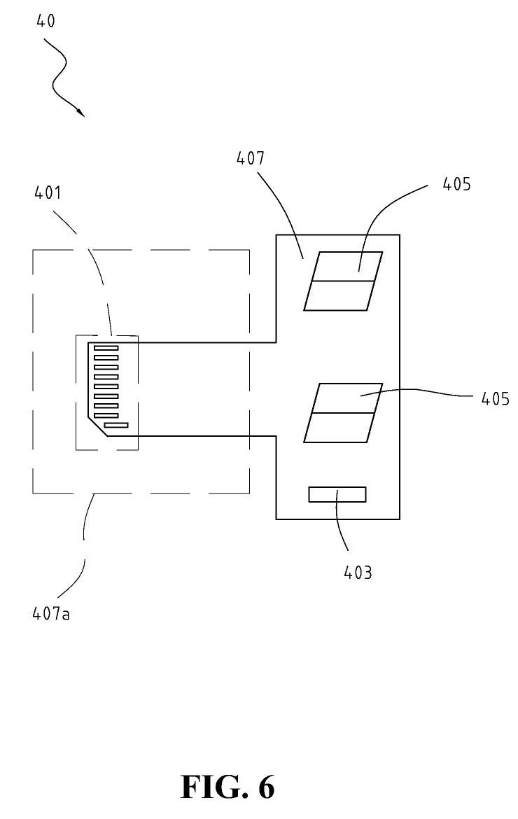

FIG. 5 is a structural view of the circuit that shows an external debug card used in combination with a debug circuit according to the invention, while FIG. 6 is a schematic view that shows the appearance of the external debug card from FIG. 5. The external debug card 40 includes: a plurality of electrical connection terminals 401, a display circuit 403, and at least more than one display element 405. The electrical connection terminals 401, the display circuit 403, and the display elements 405 are disposed on a board 407. The board 407 has a front half region 407a that includes the electrical connection terminals 401, and the front half region 407a can be inserted into the first interface 103. For example, if the first interface 103 is implemented as an electrical connection interface matching the SD memory card specification, the front half region 407a is implemented in conformity with the SD memory card specification, and a shape of the electrical connection terminals 401 is also implemented in conformity with the SD memory card specification. As a result, a user can conveniently insert the external debug card 40 into the first interface 103 implemented with the SD memory card slot, in the same way as using a SD memory card.

The display circuit 403 is allowed to receive the BIOS POST codes from the debug circuit 102 via the electrical connection terminals 401. The display element 405 is connected to the display circuit 403, wherein the display circuit 403 can be directly implemented as a display circuit using BCD to 7 Segment display known conventionally, and the display element 405 can be implemented as a displayer made of light-emitting diodes (LEDs) using BCD to 7-segment display known conventionally.

The debug device 10 of the invention utilizes a memory card slot of a card reader as an interface, so that users are allowed to examine messages about the POST codes without removing the case of a computer, which is a major advantage of the invention that does not exist in the prior arts.

In conclusion, although the present invention has been disclosed above with preferred embodiments, the embodiments cannot be used to limit the invention in any way, Various changes and modifications to the described embodiments can be carried out by any of those skilled in the art without departing from the spirit and scope of the invention, which is intended to be defined only by the appended claims.

What is claimed is:

1. A debug device sharing a memory card slot with a card reader, comprising:
a card reader controller;
a first interface being for at least more than one memory card or external debug card to be inserted thereinto, and to electrically connect the memory card and the card reader controller;
a second interface electrically connected between a computer motherboard and the card reader controller;
characterized in that: a debug circuit is electrically connected between the computer motherboard and the first interface; wherein the first interface is a multiplexed interface shared between the card reader controller and the debug circuit.

2. The debug device of claim 1, wherein the debug circuit is electrically connected between the second interface and the first interface, such that the debug circuit is electrically connected to the computer motherboard via the second interface.

3. The debug device of claim 1, wherein the debug circuit and the card reader controller are integrated to form an integrated circuit.

4. The debug device of claim 1, wherein the first interface is selected from the group consisting of an electrical connection interface matching the SD memory card specification, an electrical connection interface matching the CF memory card specification, an electrical connection interface matching the SDHC memory card specification, an electrical connection interface matching the MMC memory card specification, an electrical connection interface matching the XD memory card specification, and an electrical connection interface matching the MS memory card specification.

5. The debug device of claim 1, wherein the second interface is selected from the group consisting of an ISA interface, a PCI interface, a PCI-E interface, and an USB interface.

6. The debug device of claim 1, wherein the debug circuit is electrically connected to a chipset of the computer motherboard.

7. The debug device of claim 1, wherein the debug device is disposed in the computer motherboard.

8. The debug device of claim 1, wherein the debug device at least includes a circuit for receiving BIOS POST codes.

9. The debug device of claim 8, wherein the circuit is a PORT 80 decoding circuit.

10. The debug device of claim 8, wherein the external debug card at least includes more than one display element, in which the display elements being for displaying the BIOS POST codes.

11. The debug device of claim 1, further comprised of: a switching circuit for switching to enable one of the card reader controller or the debug circuit.
